(19) United States
(12) Patent Application Publication
(10) Pub. No.: US 2014/0230327 A1
(43) Pub. Date: Aug. 21, 2014

(54) A GASIFICATION AGENT INLET

(71) Applicants: Scott Edmondson, Wiltshire (GB); Bruce Toase, Bristol (GB)

(72) Inventors: Scott Edmondson, Wiltshire (GB); Bruce Toase, Bristol (GB)

(73) Assignee: NEW EARTH ADVANCED THERMAL TECHNOLOGIES LIMITED, Dorset (GB)

(21) Appl. No.: 14/232,127

(22) PCT Filed: Jul. 9, 2012
(86) PCT No.: PCT/GB2012/051617

§ 371 Date: Apr. 7, 2014

(30) Foreign Application Priority Data
Jul. 12, 2011 (GB) 1111923.7

(51) Int. Cl. B05B 1/00

(52) U.S. Cl. CPC B05B 1/005
USPC 48/89; 239/548

(57) ABSTRACT

A gasification inlet (2) comprising: an annular manifold having a frame (4) supporting a radially inner wall formed by a first annulus of fire bricks (6) and supporting an upper wall formed by a second annulus of fire bricks (8), the upper wall and/or the inner wall being provided with fluid flow openings (16a, 16b).

The present disclosure relates to a gasification agent inlet, and particularly, but not exclusively, to a gasification agent inlet for an updraft gasifier.

### BACKGROUND

Pyrolysis and gasification are processes which have been used in commercial energy applications for over 100 years, most notably the gasification of coke in steam engines. More recently pyrolysis and gasification have been used in waste material applications.

Pyrolysis is a thermo-chemical decomposition of organic material into char and occurs in the absence of oxygen and at elevated temperatures. By contrast, gasification converts organic materials into a number of gases including carbon monoxide, hydrogen, carbon dioxide and methane. Gasification is a process which occurs in the presence of a controlled amount of oxygen and/or steam and occurs at elevated temperatures.

The chemical science in waste applications is identical to the gasification of coke in steam engines. However, in the case of pyrolysis, the waste material is first converted into char that may then be gasified. In either case, hydrocarbons are liberated from the source fuel (char or coke) in the same way and these hydrocarbons may then be used to generate energy, for example in the form of electricity and/or heat. The pyrolysis and then gasification process (at approximately 600° C.) converts the heterogeneous waste into a homogenous high temperature gas fuel (referred to as syngas) which is then immediately oxidised (burnt) at very high temperature (approximately 1250° C.).

The combustion in either case is very complete and as such minimises the formation of pollutants such as carbon monoxide (CO), volatile organic compounds (VOCs), dioxins and particulates. Unlike conventional incineration, gas from the waste is burned, not the waste itself. Energy may then be reclaimed using a high-pressure steam boiler and turbine, or using scrubbers and a gas engine. The exhaust gases can be put through further abatement processes to ensure optimal environmental performance.

Various types of gasifier are known. In an updraft or counter current gasifier, the feed material is fed into the top of the gasifier and a gasification agent, such as air, steam or pure oxygen is blown into the base. Accordingly, the feed material flows in the opposite direction to the gasification agent—hence the name updraft or counter current.

As described previously, the gasification process produces syngas which exits the chamber towards its top. Typically, a grate will be provided which supports the feed material during the gasification process and allows ash to be periodically removed from the bottom of the gasifier.

The distribution of gasification agent through the feed material can effect the efficiency of the gasification process.

The present invention seeks to provide a gasification agent inlet which provides an even distribution of gasification agent to the feed material.

### STATEMENTS OF INVENTION

According to a first aspect of the present invention there is provided a gasification agent inlet comprising: an annular manifold having a frame supporting a radially inner wall formed by a first annulus of fire bricks and supporting an upper wall formed by a second annulus of fire bricks, the upper wall and/or the inner wall being provided with fluid flow openings.

With this arrangement, the gasification agent may be uniformly distributed to the fuel material, improving the efficiency of the gasification process.

Furthermore, the gasification agent inlet has a simple fire brick design which is both cheap and easy to produce, whilst having a long service life. This minimises costs and removes the need for complex castings.

The fire bricks in the first annulus may be disposed side by side with their longitudinal axes extending in a direction having an axial component.

The fire bricks in the first annulus may be angled such that sides of adjacent bricks are substantially in contact at one end of the bricks and are spaced from one another at the other end of the bricks thereby defining the fluid flow openings.

The fire bricks in the second annulus may be disposed side by side with their longitudinal axes extending substantially in a radial direction.

Sides of adjacent bricks in the second annulus may be substantially in contact at a radially inner end and may be spaced from one another at a radially outer end thereby defining the fluid flow openings.

The frame may comprise a first annular flange which supports the second annulus of fire bricks.

The first annular flange may extend in a substantially radial direction.

An upper end of the first annulus of fire bricks may be supported by an end surface of the first annular flange and/or by the second annulus of fire bricks.

The frame may comprise a second annular flange which projects out of the plane of the upper wall to support a radially outer end of the second annulus of fire bricks.

The first annular flange may be integrally formed with the second annular flange.

The frame may comprise a third annular flange which projects out of the plane of the radially inner wall to support a lower end of the first annulus of fire bricks.

The third annular flange may be integrally formed with the first and/or second annular flange.

The third annular flange may comprise a lip for retaining the lower end of the first annulus of fire bricks.

The frame may have openings which align with the fluid flow openings in the upper wall and/or the inner wall.

For example, the frame may comprise an annular conduit having an upper wall and an inner wall which support the fire bricks, and the openings may be formed in the upper and/or inner wall.

According to another aspect of the present invention there is provided an annular manifold having a frame supporting a radially inner wall formed by a first annulus of fire bricks and supporting an upper wall formed by a second annulus of fire bricks, the upper wall and/or the inner wall being provided with fluid flow openings.

### BRIEF DESCRIPTION OF THE DRAWINGS

For a better understanding of the present disclosure, and to show more clearly how it may be carried into effect, reference will now be made, by way of example, to the accompanying drawings, in which:

FIG. 1 is a perspective view of a gasification agent inlet comprising an annular manifold; and

FIG. 2 is a cross-sectional view of the manifold of FIG. 1.

### DETAILED DESCRIPTION

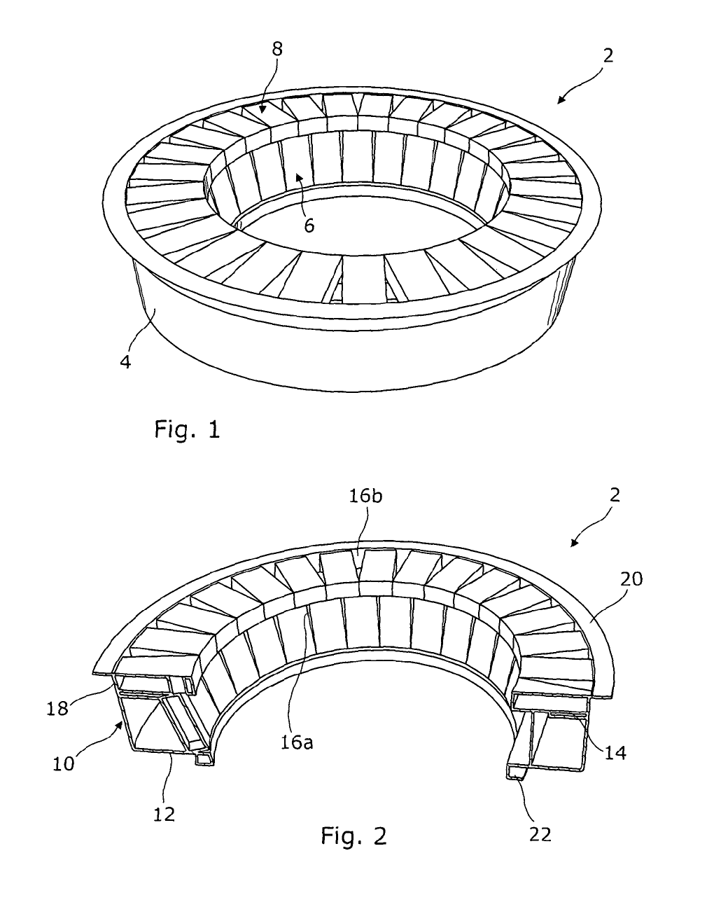

With reference to FIG. 1, a gasification agent inlet 2 according to an embodiment of the invention is shown. The gasification agent inlet 2 comprises a frame 4 formed from stainless steel, although other appropriate materials may be used.

The frame 4 is substantially annular. The frame 4 supports a first annulus of fire bricks 6 and a second annulus of fire bricks 8 to form an annular manifold, as will be described in more detail below.

As shown in FIG. 2, the frame 4 has an L-shaped cross-section defined by a wall 10 extending in a substantially axial direction and a wall 12 extending radially inward from the axial wall 10. A first annular flange 14 projects from the axial wall 10 in a radial direction. The first annular flange 14 projects partially over the radial wall 12.

The first annulus of fire bricks 6 are laid side by side around the frame 4 with the lower ends of the bricks supported by the radial wall 12 and an upper end of the bricks 6 supported by an end surface of the first annular flange 14. Accordingly, the first annulus of fire bricks 6 have their longitudinal axes substantially in an axial or vertical direction. In other words, the first annulus of fire bricks 6 extend in a direction which has at least an axial component. That said, the first annular flange 14 does not project sufficiently over the radial wall 12 for the bricks 6 to be held fully upright. Instead, they are angled back slightly. Consequently, whilst the sides of adjacent bricks 6 are substantially in contact at the lower end of the bricks 6, at the upper end, the sides of adjacent bricks are spaced from one another. The gaps between adjacent bricks 6 define a plurality of fluid flow openings 16a.

The second annulus of fire bricks 8 are laid side by side on top of the first annular flange 14, with the fire bricks 8 having their longitudinal axes oriented in a radial direction. Accordingly, the sides of adjacent bricks in the second annulus are substantially in contact at a radially inner end and are spaced from one another a radially outer end, thus forming further fluid flow openings 16b.

The second annulus of fire bricks 8 are supported along at least a part of their length by the first annular flange 14. A portion of the second annulus of fire bricks 8 may protrude over the first annular flange 14. This portion of the second annulus of fire bricks 8 may be supported by the first annulus of fire bricks 6 which are in contact with the end surface of the first annular flange 14.

An upper portion of the axial wall 10 forms a second annular flange 18. The second annular flange 18 supports the radially outer end of the second annulus of fire bricks 8.

A third annular flange (not shown) in the form of a lip may protrude substantially vertically from an inner portion of the radial wall 12 of the frame 4. The lip may retain the lower end of the first annulus of fire bricks 6.

A fourth annular flange 20 protrudes radially outwardly from an upper end of the axial wall 10. Furthermore, an annular sill 22 is provided at an inner portion of the radial wall 12 which defines a radially outwardly oriented annular recess.

In use, the gasification agent inlet 2 is received in or forms the base of an updraft gasifier. The gasification agent inlet 2 may be fixed to the gasifier using the fourth annular flange 20 and the annular sill 22. The gasification agent inlet 2 sits below a pile of fuel material for the gasification process.

The axial wall 10 and radial wall 12 of the frame 4, the first annulus of fire bricks 6 and second annulus of fire bricks 8 define an annular manifold. The annular manifold comprises an annular passageway having a plurality of fluid flow openings 16a, 16b.

A gasification agent, such as air, steam or pure oxygen, is supplied to the gasification agent inlet 2 via one or more ports (not shown). The ports may be formed in the axial wall 10 and/or radial wall 12 of the frame 4. The gasification agent enters the annular manifold and passes around the circumference of the passageway. The gasification agent exits the annular manifold through the fluid flow openings 16a, 16b formed in the first annulus of fire bricks 6 and the second annulus of fire bricks 8. Accordingly, the gasification agent is uniformly discharged by the fluid flow openings 16a, 16b and enters the fuel material for the gasification process. The gasification agent permeates through the fuel material providing an even distribution. The efficiency of the gasification process is thereby improved. The open centre of the gasification agent inlet 2 allows ash to pass through it. The ash can then be periodically removed from the gasifier.

In another embodiment, the frame may comprise a substantially solid inner axial wall and/or upper radial wall which support the first annulus of fire bricks 6 and second annulus of fire bricks 8 respectively. Furthermore, the frame may be provided by an annular conduit which forms the annular passageway and comprises the inner axial wall and upper radial wall. The inner axial wall and upper radial wall may be provided with openings which align with the fluid flow openings 16a, 16b allowing the gasification agent to exit the annular passageway.

The frame need not be integrally formed and could instead by formed as separate components. For example, standalone components may form the radial wall 12 and the first annular flange 14. These components may be connected directly to an inner wall of the gasifier. With this arrangement, the axial wall 10 and second annular flange 18 may be provided by the inner wall of the gasifier itself.

Although the invention has been described with reference to an updraft gasifier, it may be applied to other types of gasifier.

Furthermore, although the gasification agent inlet is described and shown herein as being substantially annular, the term annular is used broadly and the inlet may instead be polygonal, ovoid, or any other shape having an open centre.

1. A gasification agent inlet comprising:
an annular manifold having a frame supporting a radially inner wall formed by a first annulus of fire bricks and supporting an upper wall formed by a second annulus of fire bricks, the upper wall and/or the inner wall being provided with fluid flow openings.

2. A gasification agent inlet as claimed in claim 1, wherein the fire bricks in the first annulus are disposed side by side with their longitudinal axes extending in a direction having an axial component.

3. A gasification agent inlet as claimed in claim 2, wherein the fire bricks in the first annulus are angled such that sides of adjacent bricks are substantially in contact at one end of the bricks and are spaced from one another at the other end of the bricks thereby defining the fluid flow openings.

4. A gasification agent inlet as claimed in claim 1, wherein the fire bricks in the second annulus are disposed side by side with their longitudinal axes extending substantially in a radial direction.

5. A gasification agent inlet as claimed in claim 4, wherein sides of adjacent bricks in the second annulus are substantially in contact at a radially inner end and are spaced from one another at a radially outer end thereby defining the fluid flow openings.

6. A gasification agent inlet as claimed in claim 1, wherein the frame comprises a first annular flange which supports the second annulus of fire bricks.

7. A gasification agent inlet as claimed in claim 6, wherein the first annular flange extends in a substantially radial direction.

8. A gasification agent inlet as claimed in claim 7, wherein an upper end of the first annulus of fire bricks is supported by an end surface of the first annular flange and/or by the second annulus of fire bricks.

9. A gasification agent inlet as claimed in claim 6, wherein the frame comprises a second annular flange which projects out of the plane of the upper wall to support a radially outer end of the second annulus of fire bricks.

10-16. (canceled)

17. A gasification agent inlet as claimed in claim 6, wherein the frame comprises a second annular flange which projects out of the plane of the upper wall to support a radially outer end of the second annulus of fire bricks.

18. A gasification agent inlet as claimed in claim 17, wherein the first annular flange is integrally formed with the second annular flange.

19. A gasification agent inlet as claimed in claim 18, wherein the frame comprises a third annular flange which projects out of the plane of the radially inner wall to support a lower end of the first annulus of fire bricks.

20. A gasification agent inlet as claimed in claim 19, wherein the third annular flange is integrally formed with the first and/or second annular flange.

21. A gasification agent inlet as claimed in claim 20, wherein the third annular flange comprises a lip for retaining the lower end of the first annulus of fire bricks.

22. A gasification agent inlet as claimed in claim 19, wherein the third annular flange comprises a lip for retaining the lower end of the first annulus of fire bricks.

23. A gasification agent inlet as claimed in claim 22, wherein the frame has openings which align with the fluid flow openings in the upper wall and/or the inner wall.

24. A gasification agent inlet as claimed in claim 1, wherein the frame has openings which align with the fluid flow openings in the upper wall and/or the inner wall.

25. A gasification agent inlet as claimed in claim 1, wherein the frame comprises a second annular flange which projects out of the plane of the upper wall to support a radially outer end of the second annulus of fire bricks.

26. A gasification agent inlet as claimed in claim 1, wherein the frame comprises a third annular flange which projects out of the plane of the radially inner wall to support a lower end of the first annulus of fire bricks.

27. A gasification chamber comprising a gasification agent inlet as claimed in claim 1.
